(19) United States
(12) Patent Application Publication
(10) Pub. No.: US 2006/0142915 A1
(43) Pub. Date: Jun. 29, 2006

(54) Moving body energy management apparatus and moving body energy management method

(75) Inventors: Hiroshi Isono, Aichi (JP); Keisuke Seto, Aichi (JP); Takahiro Kodaira, Aichi (JP); Kei Takakuwa, Aichi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/545,782

(22) PCT Filed: Jun. 23, 2004
(86) PCT No.: PCT/JP04/09241

§ 371 Date: Aug. 16, 2005

(30) Foreign Application Priority Data
Jul. 17, 2003 (JP) 2003-198684

(51) Int. Cl. G06F 17/00

(52) U.S. Cl. 701/36; 701/1

(57) ABSTRACT

A moving body energy management apparatus is installed in a moving body having a supply part that supplies energy and a consumption part that consumes the energy supplied from the supply part. The consumption part includes a first part that consumes the energy for moving the moving body, which is a first function, and a second part that consumes the energy for performing a function other than moving of the moving body, which is a second function relating to the moving body. The moving body energy management apparatus includes an obtaining part obtaining environmental information relating to an environment in which the moving body is placed. A control part controls at least one of the consumption part and the supply part based on the environmental information obtained by the obtaining part such that the first function and the second function are both performed.

### TECHNICAL FIELD

The present invention relates to techniques for managing energy in a moving body including: a supply part that supplies energy; and a consumption part that consumes the energy supplied from the supply part.

### BACKGROUND ART

Techniques are already known for managing energy in a moving body including: a supply part that supplies energy; and a consumption part that consumes the energy supplied from the supply part (refer to Japanese Laid-Open Patent Application No. 8-507671). An example of the supply part is a battery, which serves as an electric energy storing part, and another example thereof is a generator, which serves as an electric energy generation part. An example of the consumption part is a motor that is electrically driven so as to apply a propulsion force to the moving body.

In the technique described in Japanese Laid-Open Patent Application No. 8-507671, a vehicle storing finite energy is handled as a moving body, and a travel route for the vehicle is selected based on navigation information relating to the vehicle. Additionally, control of energy consumption and control of charging are performed with respect to the vehicle.

Generally, the consumption part of the moving body is configured to include a first part that consumes energy for moving the moving body, which is a first function (or purpose), and a second part that consumes the energy for performing a function (or achieving a purpose) other than moving of the moving body, which is a second function (or purpose) relating to the moving body.

In cases where the moving body is an electric vehicle (including a hybrid electric vehicle), for example, an example of the first part is a motor driving the electric vehicle, and examples of the second part are: an actuator (motor or electromagnetic valve, for example) for a brake that performs braking on the electric vehicle; an actuator (motor or electromagnetic valve, for example) for a steering apparatus that steers the electric vehicle; and an actuator (motor or electromagnetic valve, for example) for an air conditioning system that adjusts the temperature, humidity, or ventilation of the cabin of the electric vehicle.

Among these examples, however, in some cases, it is reasonable to consider that the actuator for the brake and/or the actuator for the steering apparatus are not examples of the second part but examples of the first part.

In either case, it is desired for such a kind of moving body to reduce energy consumption by the moving body while fully satisfying a control request (for example, a driving request, a safety request, and a comfortability request by a user of the moving body) with respect to the moving body. That is, it is desired to simultaneously satisfy the demand for control of the moving body and the demand for energy consumption.

On this occasion, the control request is not limited to one but may be plural. In this case, it is necessary to control the moving body such that the plural control requests are simultaneously satisfied, i.e., to control the moving body in a comprehensive manner.

Further, also when considering the energy consumption by the moving body, in a case where the energy consumption is caused by a plurality of controls by the moving body, it is necessary to examine the total energy consumption by the moving body while considering all of the controls.

In short, it is preferable for the moving body to reduce the entire energy consumption by the moving body while satisfying the overall control requests for the moving body.

In order to satisfy the demand, it is preferable to control at least one of the consumption part and the supply part of the moving body such that the first function, which aims at moving the moving body, and the second function relating to the moving body, which represents function other than moving of the moving body, are both performed.

### DISCLOSURE OF THE INVENTION

It is a general object of the present invention to provide an improved and useful moving body energy management apparatus and moving body energy management method in which one or more of the above-mentioned problems are eliminated.

A more specific object of the present invention is to provide a technique for managing energy in a moving body including: a supply part that supplies energy; and a consumption part that consumes the energy supplied from the supply part such that a demand for control of the moving body and a demand for consumption energy are both satisfied.

According to the present invention, the following embodiments are achieved. Each of the embodiments is divided into an item, assigned with a number, and described by citing the number of another item if necessary. This is for facilitating comprehension of some of the technical characteristics and some of the combinations thereof described in this specification, and should not be interpreted to mean that the technical characteristics and the combinations thereof described in this specification are limited to the following embodiments.

(1) A moving body energy management apparatus installed in a moving body having a supply part that supplies energy and a consumption part that consumes the energy supplied from the supply part, the consumption part having a first part that consumes the energy for moving the moving body, which is a first function (or purpose), and a second part that consumes the energy for performing a function (or achieving a purpose) other than moving the moving body, which is a second function (or purpose) relating to the moving body, the moving body energy management apparatus including:

an obtaining part obtaining environmental information relating to an environment in which the moving body is placed; and

a control part controlling at least one of the consumption part and the supply part based on the environmental information obtained by the obtaining part such that the first function and the second function are both performed.

With the above-mentioned moving body energy management apparatus, at least one of the consumption part and the supply part is controlled for moving the moving body, which is the first function, and for achieving a function other than moving of the moving body, which is the second function relating to the moving body.

Accordingly, with the moving body energy management apparatus, compared to a case where at least one of the consumption part and the supply part is controlled such that only one of the first and second functions is achieved, it is possible to control the moving body in a comprehensive manner and perform control from both the perspectives of realization of requests relating to control and reduction of energy consumption.

Therefore, with the moving body energy management apparatus, it is possible to simultaneously satisfy a requirement with respect to control of the vehicle and a requirement with respect to the energy consumption by the vehicle by totally controlling the vehicle, i.e., controlling in a comprehensive manner.

Further, with the moving body energy management apparatus, control of at least one of the consumption part and the supply part is performed in consideration of an environment in which the moving body is placed. Hence, compared to a case where the control is performed without considering the environment, it is possible to more positively realize simultaneous satisfaction of a request with respect to control of the moving body and a request with respect to the energy consumption by the moving body.

The “supply part” in the item (1) and each of the following items is formed to include a storing part that stores energy and a generation part that generates energy. An example of the storing part is a battery, and an example of the generation part is a generator.

An example of the “first part” in the item (1) and each of the following items is a motor (electric motor) for applying a propulsion force to the moving body. An example of the “second part” is an actuator that drives each of the constituent elements of the moving body and does not contribute to the propulsion force of the moving body.

The “moving body” in the item (1) and each of the following items may be, for example, an automobile, an auto cycle, a railroad vehicle, a marine vessel, an airplane, and a rocket.

The “second function” in the item (1) and each of the following items may be, for example, a function of ensuring safety of a passenger of the moving body and a function of ensuring comfort of a passenger of the moving body.

(2) The moving body energy management apparatus as recited in the item (1),

wherein the moving body includes:

a sensor detecting at least one of a running state quantity of the moving body and the environment where the moving body is placed;

a navigation system for detecting a current position of the moving body; and

a communication apparatus for communicating with an external information transmission apparatus that is located outside the moving body and transmits information, and

wherein the obtaining part includes an information obtaining part that obtains the environmental information by using one of the sensor and the navigation system.

With the moving body energy management apparatus, at least one of the consumption part and the supply part is controlled based on a result of monitoring of the environment in which the moving body is placed. The monitoring may be performed by the moving body or may be externally performed outside the vehicle.

The “information transmission apparatus” in the item (2) may be, for example: an information delivering station such as a control center; an information transmission apparatus installed in, for instance, a road or a guide rail thereof; and another moving body.

(3) The moving body energy management apparatus as recited in the item (1) or (2), wherein the control part includes an estimation-type control part that estimates a state of the moving body, which state includes a future position of the moving body, based on the environmental information obtained by the obtaining part, and controls at least one of the consumption part and the supply part based on the estimated state of the moving body.

In order to manage energy in the moving body with good accuracy, it is important to estimate the energy consumption with a time span as long as possible. On the other hand, it is possible to estimate the energy consumption characteristics of the moving body through considering an environment in which the moving body is placed.

Based on the knowledge, with the moving body energy management apparatus according to the item (3), the state of the moving body, which state includes a future position of the moving body, is estimated based on the environment in which the moving body is placed, and at least one of the consumption part and the supply part is controlled based on the estimated state of the moving body.

(4) The moving body energy management apparatus as recited in any of the items (1) through (3), wherein the control part includes:

a target setting part setting a target toward which the moving body is to be controlled;

a travel route/driving mode determination part determining the travel route and the driving mode of the moving body based on the set target and the obtained environmental information such that the energy consumption by the first part of the consumption part becomes as small as possible;

a target remaining energy determination part determining target remaining energy of the supply part based on the obtained environmental information;

an actuation mode determination part determining an actuation mode of the second part based on the set target such that the energy consumption of the second part of the consumption part does not become less than the determined target remaining energy; and

a realizing part realizing movement of the moving body in the determined driving mode along the determined travel route and actuation of the second part in the determined actuation mode.

The “remaining energy” in the item (4) and each of the following items is used as a term to represent, for example, the state of charge SOC of a battery in a case where the supply part is formed to include the battery.

(5) The moving body energy management apparatus as recited in any of the items (1) through (4), wherein the control part includes a supply part control part that estimates the state of the moving body, which state includes the future position of the moving body, based on the environmental information obtained by the obtaining part, and based on the estimated state of the moving body, controls the supply part with respect to energy supply between the moving body and an external energy related apparatus located outside the moving body.

In a case where the supply part of the moving body is formed as, for example, an energy storing part (e.g., a battery), the energy that can be supplied is limited. Additionally, in a case where the supply part is formed as an energy generation part (e.g., a power system), it is difficult to indefinitely generate energy as long as the energy is consumed by the generating part. Hence, also in this case, the energy that can be supplied is limited.

Accordingly, in any case, there is a possibility that the energy that can be supplied from the supply part may fall short, and in this case, it is necessary to replenish the shortfall from outside the moving body.

On the other hand, in a case where the supply part is formed as the energy generation part, there is a possibility that the generation part may generate energy more than necessary. In this case, if the excess energy is discharged to the outside of the moving body, the energy is more effectively used in the society as a whole.

Further, as mentioned above, in order to manage energy in the moving body with good accuracy, it is important to estimate the energy consumption in a time span as long as possible. On the other hand, it is possible to estimate the energy consumption characteristics of the moving body through considering the environment in which the moving body is located.

Based on the above knowledge, with the moving body energy management apparatus, the state of the moving body, which state includes a future position of the moving body, is estimated based on the environment in which the moving body is placed. Based on the estimated state of the moving body, the supply part is controlled with respect to energy supply between the supply part and the external energy related apparatus located outside the moving body.

The “external energy related apparatus” in the item (5) may be, for example, a replenishment system that replenishes energy to a storing part in a case where the supply part of the moving body is formed as the storing part.

Additionally, in a case where the storing part is formed as a cartridge type storing part, which is detachable from the moving body, the “external energy related apparatus” is an apparatus for preparing a replacement energy-storing cartridge that is charged.

(6) The moving body energy management apparatus as recited in the item (5), wherein the supply part control part includes a replenishment control part that, in a case where the energy remaining in the supply part in a time period during which the supply part can access the external energy related apparatus falls short of the energy to be thereafter consumed by the consumption part, controls the supply part such that the deficient energy is replenished from the external energy related apparatus.

(7) The moving body energy management apparatus as recited in the item (5) or (6), wherein the supply part control part includes a discharge control part that, in a case where the energy remaining in the supply part in a time period during which the supply part can access the external energy related apparatus is excessive for the energy to be thereafter consumed by the consumption part, controls the supply part such that the excess energy is discharged from the supply part to the external energy related apparatus.

(8) The moving body energy management apparatus as recited in any of the items (1) through (3), and the items (5) through (7), wherein the control part includes:

a target setting part setting a target toward which the moving body is to be controlled;

a travel route/driving mode determination part determining the travel route and the driving mode of the moving body based on the set target and the obtained environmental information such that the energy consumption by the first part of the consumption part becomes as small as possible;

a replenishment location/replenishment mode determination part determining the replenishment location at which energy is replenished to the supply part in the middle of the determined travel route and the replenishment mode;

a target remaining energy determination part determining a target remaining energy amount of the supply part based on at least a relative position of the moving body with respect to the determined replenishment location included in the obtained environmental information and the relative position;

an actuation mode determination part determining an actuation mode of the second part based on the set target such that the energy consumption of the second part of the consumption part does not become less than the determined target remaining energy amount; and

a realizing part realizing movement of the moving body in the determined driving mode along the determined travel route and actuation of the second part in the determined actuation mode.

(9) A moving body energy management method applied to a moving body having a supply part that supplies energy and a consumption part that consumes the energy supplied from the supply part, the consumption part having a first part that consumes the energy for moving the moving body, which is a first function (or purpose), and a second part that consumes the energy for performing a function (or achieving a purpose) other than moving of the moving body, which is a second function (or purpose) relating to the moving body,

the method including the steps of:

obtaining environmental information relating to an environment in which the moving body is placed; and

controlling at least one of the consumption part and the supply part based on the environmental information obtained in the step of obtaining environmental information such that the first function and the second function are both performed.

With the above-mentioned moving body energy management method, it is possible to realize the functions and effects that are fundamentally the same as those of the apparatus of the item (1) based on the principle fundamentally the same as that of the apparatus of the item (1).

It is possible to perform the method of the item (9) together with the step that performs the function to be accomplished by each of the constituent elements recited in any of the above-mentioned items (1) through (8).

Other objects, features and advantages of the present invention will become more apparent from the following detailed description when read in conjunction with the following drawings.

### BRIEF DESCRIPTION OF THE DRAWINGS

FIG. 1 is a block diagram conceptually showing a driving support apparatus including a moving body energy management apparatus according to one embodiment of the present invention together with a vehicle mounting the driving support apparatus thereon;

FIG. 2 is a perspective view conceptually showing the usage of the driving support apparatus shown in FIG. 1;

FIG. 3 is a block diagram conceptually showing a hardware structure of the driving support apparatus shown in FIG. 1;

FIG. 4 is a block diagram conceptually showing a software structure of the driving support apparatus shown in FIG. 1;

FIG. 5 is a flowchart conceptually showing the contents of a driving support program stored in the ROM shown in FIG. 3;

FIG. 6 is a graph for explaining the driving support program of FIG. 5;

FIG. 7 is another graph for explaining the driving support program of FIG. 5; and

FIG. 8 is still another graph for explaining the driving support program of FIG. 5;

### BEST MODE FOR CARRYING OUT THE INVENTION

A detailed description is given below of one embodiment of the present invention, with reference to the drawings.

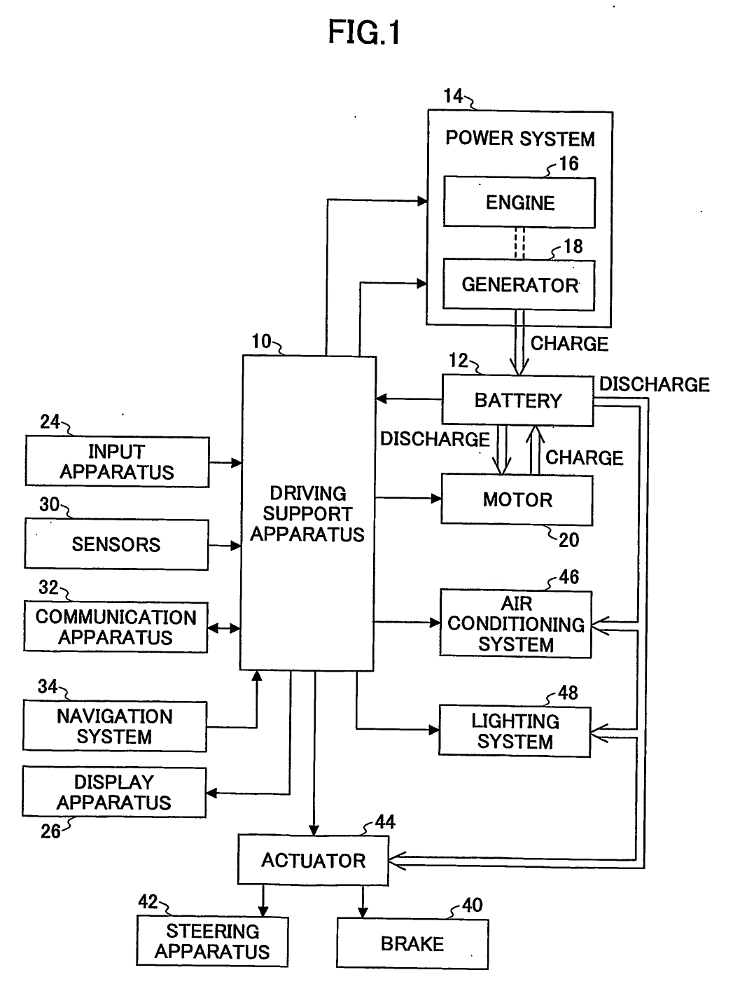

FIG. 1 is a block diagram conceptually showing a driving support apparatus 10 including a moving body energy management apparatus according to one embodiment of the present invention, together with a vehicle (hereinafter referred to as “the vehicle”) mounting the driving support apparatus 10 thereon. The driving support apparatus 10 carries out a moving body energy management method according to another aspect of the present invention. In the present embodiment, an automobile serves as an example of the “moving body” in the above-mentioned item (1).

The vehicle may adopt various driving systems. In the present embodiment, however, the series hybrid system is adopted. Specifically, the vehicle includes: a battery 12, which serves as a storage apparatus; an engine (internal combustion engine) 16 and a generator 18 driven by the engine 16, which serve as a power system; and a motor 20, which serves as a driving apparatus.

The motor 20 is driven by electric power supplied from the battery 12, thereby driving the vehicle. It is possible for the motor 20 to function as a second generator at the time of braking of the vehicle. In other words, it is possible for the battery 12 to be charged by the power system 14 and by regenerative braking of the motor 20, and the motor 20 forms an energy regeneration apparatus.

As shown in FIG. 1, the vehicle is provided with an input apparatus 24, which is operated to input an instruction of a user of the vehicle to the driving support apparatus 10. Further, the vehicle is provided with a display apparatus 26 for making necessary information visible.

The vehicle is provided with several information obtaining devices for obtaining environmental information relating to the environment (including the state quantities of the vehicle) in which the vehicle is currently located or an environment in which the vehicle may be located at a future date.

The information obtaining devices include various sensors 30, which detect the state quantities of the vehicle such as the running state quantity of the vehicle (for example, vehicle speed, vehicle acceleration/deceleration, wheel speed, wheel acceleration, tire longitudinal force, tire turning angle, tire inflation pressure, angle of inclination of the vehicle, and movable load), the road surface state quantity (road surface μ, etc.), and the cabin temperature.

Further, the information obtaining devices include: a communication apparatus 32 (including a mobile telephone, an automobile telephone and the like used within the vehicle) for communicating with the outside; and a navigation system 34, which creates information related to the position of the vehicle and a travel route thereof. The navigation system 34 has a function of displaying necessary information on the screen of the display apparatus 26. The navigation system 34 has a function of specifying the current position of the vehicle on a road map by using the GPS functions. Further, the vehicle may be provided with a camera, which photographs a front image, a rear image, or a side image of the vehicle, as one of the information obtaining devices.

As shown in FIG. 1, the vehicle is further provided with the motor (vehicle driving apparatus) 20, a brake (vehicle braking apparatus) 40, and a steering apparatus 42 for controlling the movement of the vehicle. Among these, the brake 40 and the steering apparatus 42 are actuated by an actuator (motor or electromagnetic valve, for example) 44. The actuator 44 is driven by electric power from the battery 12.

The vehicle is further provided with an air conditioning system 46, which has a function of adjusting the cabin temperature, a ventilating function, which is described below, a heat exchange function, and a water cooling function. The air conditioning system 46 is driven by electric power from the battery 12. The vehicle is further provided with a lighting system 48, which illuminates the outside. The lighting system 48 is also actuated by electric power from the battery 12.

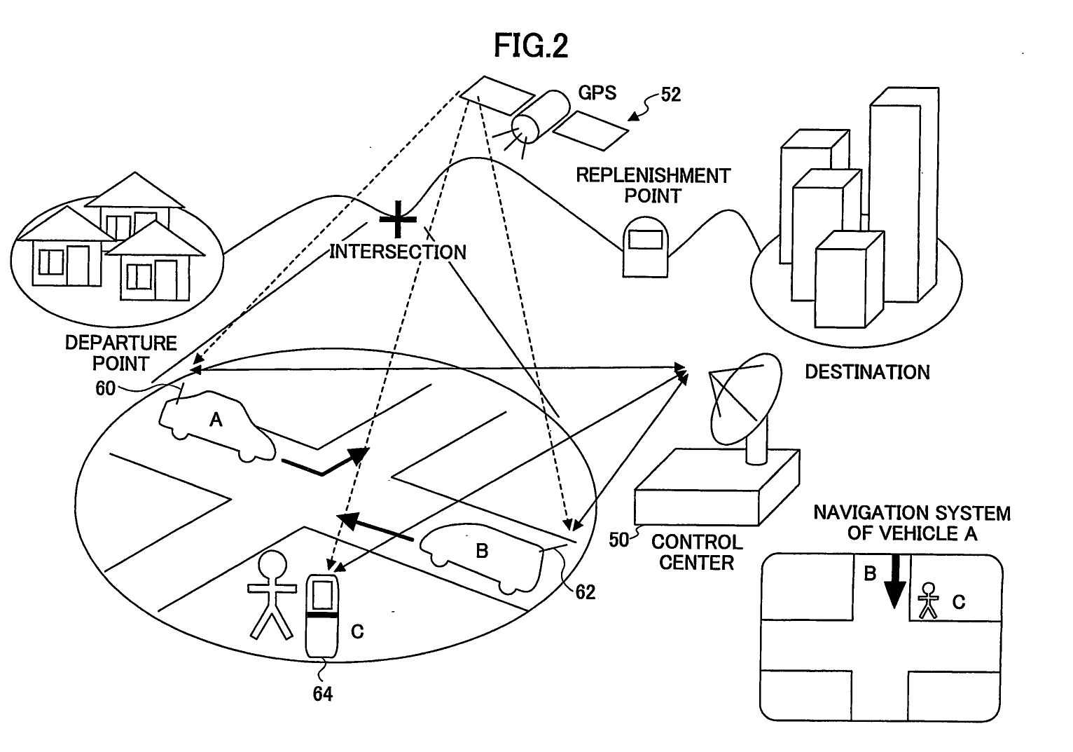

FIG. 2 conceptually shows the usage of the driving support apparatus 10. The driving support apparatus 10 is used for optimizing the travel route from a departure point to a destination, the driving mode, and the driving speed by communicating with the outside (for example, another vehicle (including a railroad vehicle) B, a pedestrian C, a control center 50, and a satellite 52 for GPS) according to need in order to minimize the energy consumption of a vehicle A.

In FIG. 2, the travel route selected with respect to the vehicle A is indicated by a curved continuous line connecting the departure point and the destination to each other, and an intersection and a replenishment point are shown in the middle of the travel route. The intersection is shown in an enlarged manner, and a relative positional relationship among the vehicle A, the vehicle B, and the pedestrian C are shown. In the bottom right of FIG. 2, a display on the screen of the display apparatus 26 made by the navigation system 34, which is mounted on the vehicle A, is shown.

It is possible for each of the vehicle A, the vehicle B, and the pedestrian C to detect the current position by using antennas 60 and 62 (or mobile telephones that users of the vehicles A and B take along), a mobile telephone 64 that the pedestrian C takes along, and a GPS 52.

The vehicle A, the vehicle B, and the pedestrian C can perform information exchange with one another. Specifically, the vehicle A and the vehicle B can exchange information with each other by using the respective antennas 60 and 62 via the control center 50. Further, the vehicle A, the vehicle B, and the pedestrian C can exchange information with each other by using the antenna 60, the antenna 62, and the mobile telephone 34 that the pedestrian C takes along, respectively, via the control center 50.

The driving support apparatus 10 further obtains information relating to: for example, the location of the replenishment point for replenishment of energy, which replenishment point the vehicle A passes by during the travel to the destination; the replenishment mode; and the possible capacity for replenishment, and determines a travel route, the driving mode, and the driving speed by estimating the possibility for energy replenishment in the future.

Additionally, the driving support apparatus 10 determines the driving speed such that the vehicle crosses all of the intersections on the travel route on a green light as much as possible, i.e., without stopping. This is because the energy consumption by the vehicle tends to increase in proportion to frequent repetition of acceleration and deceleration by the vehicle during the travel.

Further, the driving support apparatus 10 optimizes the driving states (the “operation mode” in the above-mentioned items (4) and (8)) of the actuator 44, the air conditioning system 46, and the lighting system 48 by estimating the necessity for charging (charging possibility) of the battery 12 in the vehicle.

As is clear from the above description, the driving support apparatus 10 is mounted on the vehicle for supporting ideal realization of energy-saving driving, which is generally referred to as “Eco-Run”, while allowing a driver to have the initiative in driving the vehicle.

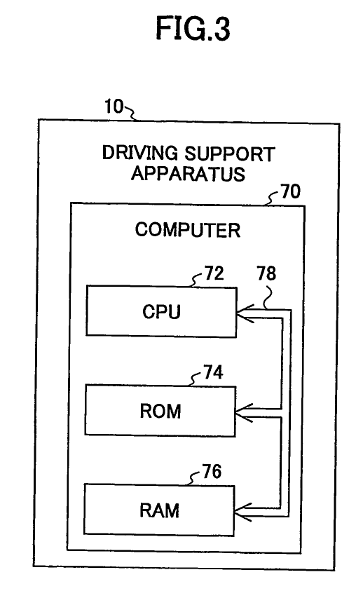

FIG. 3 is a block diagram conceptually showing the hardware structure of the driving support apparatus 10. The driving support apparatus 10 includes a computer 70 as a main body. As is well known, the computer 70 includes a CPU 72, a ROM 74, and a RAM 76, which are connected to each other via a bus 78. A driving support program, which is necessary for driving support, is stored in the ROM 74 beforehand, and the driving support program is carried out by the CPU 72. Thereby, the driving support in the vehicle is performed.

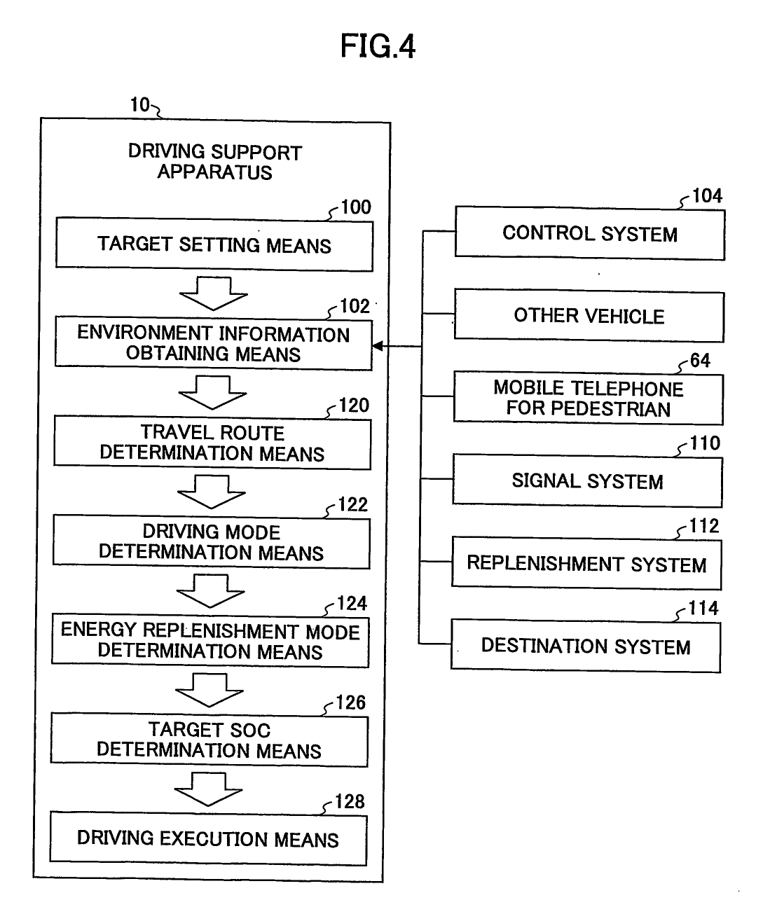

FIG. 4 shows a function block diagram of the software structure of the driving support apparatus 10 and a block diagram of plural parties that communicate with the driving support apparatus 10.

Specifically, the driving support apparatus 10 includes: target setting means 100 for setting a control target of the vehicle; and environmental information obtaining means 102 for obtaining the environmental information mentioned above. The environmental information obtaining means 102 can communicate with the parties, which are located outside the vehicle. The parties include a control system 104, another vehicle, the mobile telephone 64 for a pedestrian, a signal system 110, a replenishment system 112, and a destination system 114.

The control system 104 is installed in the control center 50 shown in FIG. 2. The control system 104 has a function of delivering to each vehicle traffic information relating to, for example, traffic jams, closure for construction, and accident information. The control system 104 further has a function of serving as a medium of communications between the vehicle and another vehicle and between the vehicle and the pedestrian. With the latter function, it is possible for the vehicle to obtain the positions of the other vehicle and the pedestrian.

The signal system 110 has a function of delivering to each vehicle a signal switching program (that controls signal switching patterns) of a traffic signal (hereinafter also simply referred to as the “signal”) installed in the intersection shown in FIG. 2.

The replenishment system 112 is installed in the replenishment point shown in FIG. 2 and performs energy replenishment of the vehicle. Prior to the replenishment, the replenishment system 112 communicates with the vehicle and receives from the vehicle information relating to the energy replenishment suitable for the vehicle. The replenishment system 112 may supply energy to the vehicle in various manners.

Specifically, the replenishment system 112 may adopt, for example, a method of charging the battery 12 of the vehicle by means of a generator (not shown) provided in the replenishment system 112. Additionally, in a case where the battery 12 of the vehicle is constructed as an exchangeable energy storing module (energy storing cartridge), a method (cartridge exchange method) may be alternatively or additionally adopted in which the energy storing module is replaced with another energy storing module that is fully charged.

The destination system 114 is installed in the destination shown in FIG. 2. Similar to the replenishment system 112, the destination system 114 has a function of supplying energy to the vehicle in various manners. Additionally, the destination system 114 has a function of delivering to each vehicle information relating to empty spaces in parking areas in the vicinity of the destination.

As shown in FIG. 4, the driving support apparatus 10 is further provided with travel route determination means 120 for determining an optimum route for the vehicle to travel in order to arrive at the destination based on the set target and the obtained environmental information.

The driving support apparatus 10 is further provided with driving mode determination means 122 for determining an optimum mode for driving the vehicle during the travel to the destination along the travel route selected based on the set target and the obtained environmental information.

The driving mode determination means 122 determines the driving speed of the vehicle such that the frequency of stopping the vehicle at red lights at the time of passing intersections and the frequency of decelerating the vehicle for avoiding near collisions with respect to other vehicles in front of the vehicle, for example, become as low as possible. This is because frequent accelerating/decelerating results in an increase in the energy consumption by the vehicle.

Further, the driving mode determination means 122 determines whether it is possible for the vehicle to follow the vehicle in front while maintaining a distance therebetween shorter than a normal distance. When it is possible, the driving mode determination means 122 determines the driving speed of the vehicle such that the vehicle follows the vehicle in front at a shortened distance. This is because, if the vehicle can use the slipstream of the vehicle in front, the air resistance of the vehicle is reduced, which results in a reduction of the energy consumption.

As shown in FIG. 4, the driving support apparatus 10 is further provided with energy replenishment mode determination means 124. The energy replenishment mode determination means 124 determines: a replenishment location at which the vehicle should be replenished with energy therefor; the quantity of energy to be replenished; the power generation capacity and the power storage capacity (loading energy capacity) that the vehicle should possess for the travel; and the mode for replenishing energy.

The mode for replenishing energy includes, for example: a mode in which replenishment is made by charging at a selected replenishment location; and a mode in which the energy storing module is replaced with another energy storing module at the replenishment location. In a case where, for example, a target replenishment time period at the replenishment point is shorter than a set time period, the energy replenishment mode determination means 124 selects an exchange mode of exchanging the energy storing module. In a case where the target replenishment time period is longer than the set time period, the energy replenishment mode determination means 124 selects a charging mode of charging the battery 12 at a rate corresponding to the target replenishment time period.

In a case where an excess energy storing point exists in the selected travel route, the energy replenishment mode determination means 124 causes the battery 12 of the vehicle to discharge under the condition that the energy amount of the vehicle remains more than sufficient at the time when the vehicle passes by the excess energy storing point. Thereby, such excess energy is stored in the excess energy storing point. The stored energy may be used for various applications.

As shown in FIG. 4, the driving support apparatus 10 is further provided with target SOC determination means 126. The target SOC determination means 126 determines a target value for the state of charge SOC of the battery 12 of the vehicle based on, for example: the altitude of the vehicle (relating to potential energy); the possibility that the battery 12 will be charged by regenerative braking during a set time period; and the possibility that the vehicle will arrive at the replenishment point within a set time period and energy is replenished to the vehicle.

Specifically, the target SOC determination means 126 determines as a target SOC the value that the state of charge SOC of the battery 12 of the vehicle should take at the time of starting of deceleration of the vehicle such that, for example, the state of charge SOC of the battery 12 has a magnitude that does not exceed an upper limit value (a magnitude that does not cause the battery 12 to be overcharged) due to energy regeneration caused by subsequent deceleration.

That is, the target SOC determination means 126 determines the target value for the state of charge SOC at the time of starting of deceleration in consideration of the energy regeneration due to deceleration that is to be performed by the vehicle.

The target SOC determination means 126 further determines as a target SOC the value that the state of charge SOC of the battery 12 of the vehicle should take at the time of starting of running a downhill slope such that the state of charge SOC of the battery 12 has a value that does not exceed the upper limit value (a value that does not overcharge the battery 12) due to energy regeneration caused by running the downhill slope.

That is, the target SOC determination means 126 determines the target value for the state of charge SOC at the time of starting of running of the downhill slope in consideration of the energy regeneration caused by running of the downhill slope to be performed by the vehicle.

The target SOC determination means 126 further determines as target SOCs the values that the state of charge SOC of the battery 12 of the vehicle should take at the times of arrivals of the replenishment point, the excess energy storing point, and the destination so that as a result the vehicle runs along the determined travel route in the determined driving mode.

As shown in FIG. 4, the driving support apparatus 10 is further provided with driving execution means 128. The driving execution means 128 have a function of driving the vehicle in the determined driving mode along the determined travel route. In order to realize the function, the driving execution means 128 control the tire longitudinal force and the tire turning angle of the vehicle via the actuator 44.

The driving execution means 128 also have a function of controlling, for example, the actuator 44, the air conditioning system 46, and the lighting system 48 in accordance with the determined target SOCs. The driving execution means 128 further have: a function of driving the power system 14 so that the determined target SOCs are achieved; a function of controlling the energy regeneration apparatus so that the target SOCs are achieved; and a function of controlling energy replenishment of the vehicle so that the target SOCs are achieved at the replenishment point.

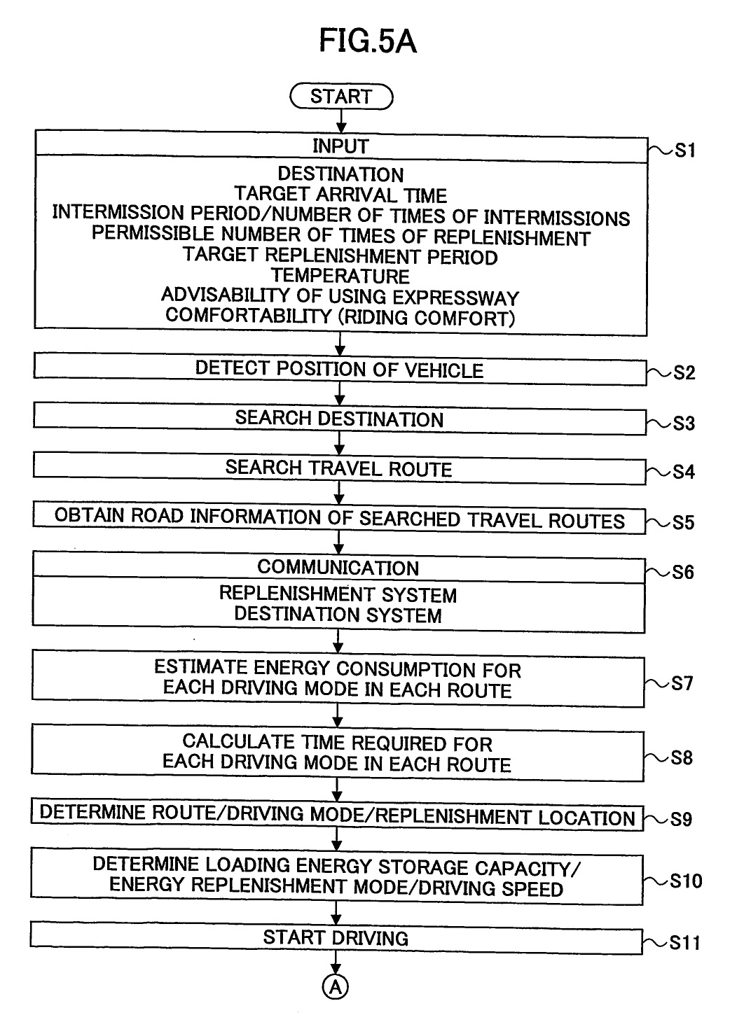

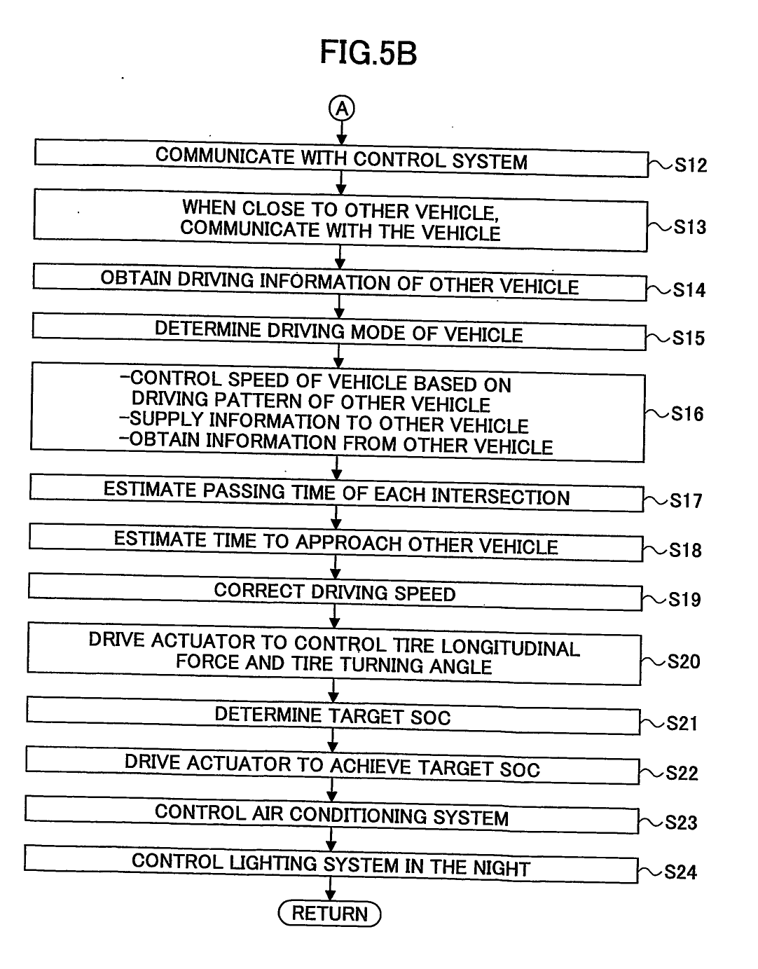

FIG. 5 is a flow chart conceptually showing the contents of the driving support program stored in the ROM 74. In the driving support program, first, an input is made by a driver by using the input apparatus 24 in step S1 (Hereinafter simply referred to as “S1”. The same applies to the other steps.). Specifically, the following various parameters are input:
destination at which the vehicle should arrive (specified by a coordinate, for example)
target arrival time, which is a target value for a time period required for arriving at the destination
intermission period and the number of intermissions that the driver takes until the vehicle arrives at the destination
permissible number of times of replenishment, which is a permissible value for the number of times of replenishment of energy to the vehicle until the vehicle arrives at the destination
target replenishment period, which is a target value for the time period consumed by the vehicle at the replenishment point
target temperature, which is a target value for the cabin temperature of the vehicle
advisability of using expressways until the vehicle arrives at the destination
whether the driver give priority to comfort (riding comfort) upon selection of roads
target value for energy consumption.

Next, in S2, the position of the vehicle is detected by using, for example, the navigation system 34 and the GPS. Subsequently, in S3, the destination is searched for on the navigation system 34.

Then, in S4, plural travel routes from the current position of the vehicle to the destination are searched for on the navigation system 34.

The searched for travel routes include a travel route having the shortest distance between the departure point and the destination, and a travel route having a distance longer than the shortest distance but less than a set value.

Additionally, there is a possibility that a travel route using expressways may be searched for. However, when the use of expressways is prohibited in the input performed in S1, those travel routes that use expressways are eliminated.

Further, there is a possibility that a travel route using rough roads such as an unpaved road, a mountain trail, and a dirt road may be searched for. However, when the priority is given to comfort in the input performed in S1, those travel routes using rough roads are eliminated.

Subsequently, in S5, road information relating to each of the searched for travel routes is obtained from, for example, the control system 104. The road information includes, for example: whether there is road construction; whether the road is blocked due to natural calamity; and whether there is a traffic jam.

Then, in S6, communication is performed with other parties. For example, communication is performed with the replenishment system 112, which is in the middle of each of the travel routes, and the destination system 114, which is installed at the destination of this time. Through these communications, for example, the waiting time for energy replenishment, the time required, and whether there is an accidental abnormality are received from the replenishment system 112. On the other hand, information of the same kind as the information from the replenishment system 112, i.e., the degree of congestion at the parking place in the destination, for example, is received from the destination system 114.

Subsequently, in S7, the energy consumption of the vehicle is estimated for each driving mode in each travel route. The driving mode may be defined in various manners. For example, the driving mode may be defined based on the driving speed of the vehicle to include low speed running, middle speed running, and high speed running. Additionally, the driving mode may be defined based on the acceleration of the vehicle to include gradual acceleration running, intermediate acceleration running, and rapid acceleration running.

It should be noted that the speed at which the vehicle is to be driven and the acceleration at which the vehicle is to be accelerated are defined through calculation in consideration of the target arrival time mentioned above.

In S7, generally, the energy consumption of the vehicle is calculated in consideration of the travel route until the destination and the driving mode based on the current position of the vehicle. That is, the running states that the vehicle will experience while running from the current position toward the destination are estimated based on the obtained environmental information, and the energy to be consumed by the vehicle in order to realize the driving states is estimated.

Consequently, in S7, the energy consumption is estimated for the entire vehicle and the entire series of travel routes for the vehicle.

In the steps following S7, for example, the motor 20, the actuator 44, and the air conditioning system 46, which form the consumption part of the vehicle, are controlled in relation to the energy consumption thus estimated.

In S7, the energy consumption may be estimated by adding the energy consumption of the air conditioning system 46 of the vehicle in consideration of the target cabin temperature.

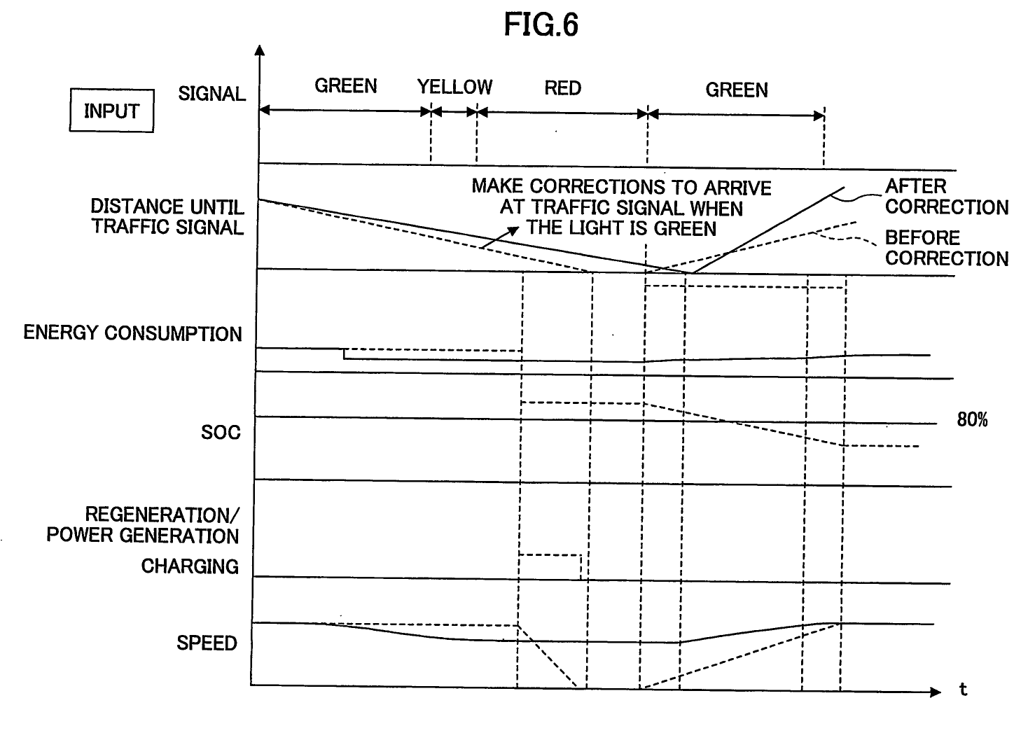

In S7, the energy consumption of the vehicle is estimated in association with each point on each travel route. FIGS. 6 through 8 are graphs conceptually showing the time shift of the estimate of the energy consumption (for example, electric power in a narrow sense at each moment) in several examples.

Additionally, it should be noted that, in this specification, the term “electric power” is used as a term representing electric power in a narrow sense and also a term representing electric power in a wider sense including electric power in the narrow sense and electric energy in a narrow sense. The definition of the term “electric power” depends on the context.

In S8 of FIG. 5, a time period (required time period for arrival) required for the vehicle to arrive at the destination is calculated for each driving mode in each route. The required time period for arrival is calculated for each of the combinations of the travel routes and the driving modes.

Subsequently, in S9, the optimum travel route, the optimum driving mode, and the optimum energy replenishment location (the replenishment point optimum for the vehicle) are determined based on the estimated energy consumption, the calculated required time period for arrival and in consideration of the various parameters that are input by the driver. The optimum energy replenishment location is determined in consideration of, for example: the target arrival time, the number of times of intermission, the target value (saving level) for the energy consumption, and the amount of energy at which replenishment is required. On this occasion, the initial value of the charge of state SOC of the battery 12 and a required value relating to the capacity of the battery 12 are also determined according to need.

Then, in S10, the loading energy (for example, the sum of the storage capacity of the fuel (consumed by the engine 16) loaded in the fuel tank of the vehicle and the capacity (for example, the state of charge, which is described later) of the battery 12) required to be loaded in the vehicle at the time of starting of running in order for the vehicle to arrive at the destination within the target arrival time, the optimum energy replenishment mode (whether to apply a charging mode or an exchange mode is determined in accordance with the input target replenishment period), and the driving speed of the vehicle are determined. FIGS. 6 through 8 show the time shift of the determined value of the driving speed in the several examples.

In S11 of FIG. 5, driving of the vehicle is started. Then, in S12, communications are performed between the vehicle and the control system 104. As a result of the communications, it is determined whether another vehicle (and/or a pedestrian) exists in the vicinity of the vehicle. The control system 104 serves as an interface between the vehicle and another vehicle that is strange to the vehicle. Thereby, it is possible for the vehicle to perform individual communications with the other vehicle, which relates to the vehicle.

Then, in S13, referring to the result of the communications, it is determined whether there is a possibility that the other vehicle may approach the vehicle. When there is such a possibility, communications are performed between the vehicle and the other vehicle. It should be noted that, in the present embodiment, “the other vehicle” may be a vehicle running in the same direction as the vehicle and positioned in front of, in the rear of, or at the side of the vehicle, and an oncoming vehicle running in the direction opposite to that of the vehicle.

In S14, driving information of the other vehicle is obtained. The driving information includes, for example: the destination at which the other vehicle is to arrive; the travel route to the destination; the driving speed; in a case where the vehicle shifts lanes, whether the other vehicle shifts lanes to the right or the left of the other vehicle; the time required for overtaking; whether cornering is required; whether braking is required; the loading status in a case where the other vehicle is a freight car; and whether the other vehicle is in an emergency condition such as the jumping in of still another vehicle.

In S15, the driving mode of the vehicle is additionally determined. For example, whether it is necessary for the vehicle to shift lanes, whether it is necessary to overtake, whether it is suitable to follow another car, and whether it is necessary to adjust the distance between the vehicle and the other vehicle are determined, and the driving mode is additionally determined so as to reflect the result. On this occasion, in a case where a leading vehicle, i.e., the other vehicle, is a freight car, considering that it is difficult for the freight car to stop immediately because of the heavy live load thereof, the driving mode (for example, running state and braking deceleration) of the vehicle is determined such that the distance between the vehicle and the freight car becomes longer than ordinary.

Subsequently, in S16, based on the obtained driving information of the other vehicle, the speed of the vehicle is controlled to match the driving pattern (driving mode) of the other vehicle.

Additionally, in S16, the driving information of the vehicle is transmitted to the other vehicle. The driving information includes, for example: the point at which the vehicle overtakes the other vehicle; that it is preferable for the other vehicle to decelerate when overtaken by the vehicle; information relating to the opposite lane on which the vehicle runs temporarily at the time of overtaking; that the vehicle overtakes the other vehicle by turning to the right.

Further, in S16, the driving information of the other vehicle is received by the vehicle. The driving information includes, for example: whether the other vehicle allows the vehicle to overtake the other vehicle; whether the other vehicle allows the vehicle to turn to the right for overtaking the other vehicle; and information relating to pedestrians or obstructions.

That is, by executing S16, two-way communications are performed between the vehicle and the other vehicle. Consequently, the driving modes of both vehicles are cooperatively corrected.

Then, in S17, based on necessary information included in the information obtained thus far and the information obtained through communications with the signal system 110, the information is obtained that relates to the signal switching time of a signal of an intersection through which the vehicle passes. Thereby, the time at which the vehicle passes through each intersection on the selected travel route is estimated. The estimation is carried out so that the vehicle can pass through as many intersections on a green light as possible and thereby realize energy-saving running.

In S18, in a case where the other vehicle is a leading vehicle, the time is estimated at which the vehicle becomes close to the leading car with a set distance or less based on necessary information from the information obtained thus far.

In S19, the driving speed determined in S10 is corrected according to need.

Specifically, the driving speed is corrected based on the estimation result in S17 so as to satisfy the condition that the vehicle does not need to stop at a red light when passing through an intersection. This is for reducing energy consumption by suppressing the frequency of accelerating and decelerating the vehicle at signals. FIG. 6 shows a case where the driving speed is corrected in the aforementioned manner: the continuous lines represent the corrected driving speed, and the broken lines represent the driving speed before the correction.

Additionally, in S19, based on the estimation result in S18, it is determined whether there is ample time until the vehicle approaches the other vehicle. When there is not amply time, the driving speed of the vehicle is corrected to a lower speed, thereby preventing a situation where the vehicle becomes excessively close to the other vehicle and is forced to reduce the speed (including braking). When deceleration is performed, acceleration follows thereafter. Such frequent acceleration and deceleration is disadvantageous to reducing the energy consumption of the vehicle.

Further, in S19, based on the estimation result in S18, it is determined whether it is possible for the vehicle to follow the car in front with a following distance shorter than usual. When it is possible, the driving speed of the vehicle is corrected to follow the vehicle in front with a shorter following distance. This is for reducing the energy consumption of the vehicle by using slipstream to reduce air resistance of the vehicle.

Then, in S20, among the motor 20 and the actuator 44, those involved in driving control are controlled such that the vehicle is driven in the determined optimum driving mode along the determined optimum travel route. For example, in order to control the tire longitudinal force of the vehicle, the motor 20 and the actuator 44, which actuates the brake 40, are controlled. In order to control the tire turning angle, the actuator 44, which actuates the steering apparatus 42, is controlled. The control may be performed for supporting the driver to drive the vehicle or substantially eliminating driving by the driver.

Subsequently, in S21, a target SOC for the vehicle is determined. For example, a target value for the state of charge SOC at the starting of deceleration is determined in consideration of energy regeneration caused by deceleration to be performed by the vehicle.

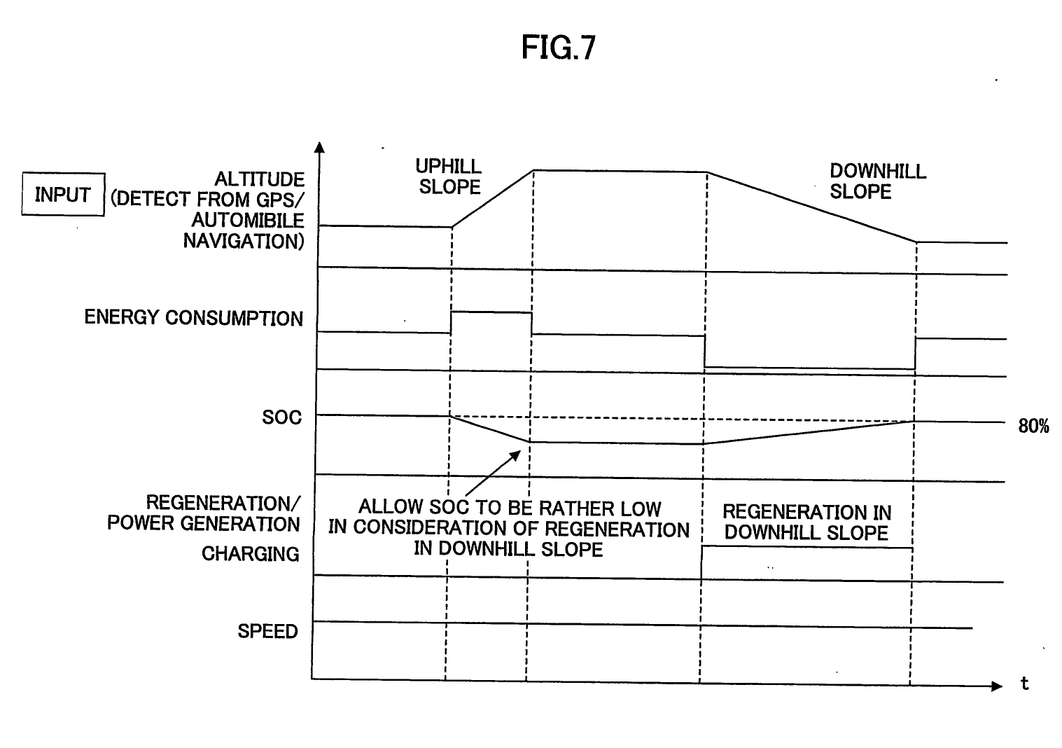

Additionally, in S21, a target value for the state of charge SOC at the starting of running of a downhill slope is determined in consideration of energy regeneration caused by the running of the downhill slope to be performed by the vehicle. Specifically, as shown in FIG. 7, the target SOC in a term (for example, a running term at a high altitude) preceding the running of the downhill slope is determined such that the state of charge SOC is allowed to be below a set permissible value (for example, 80%).

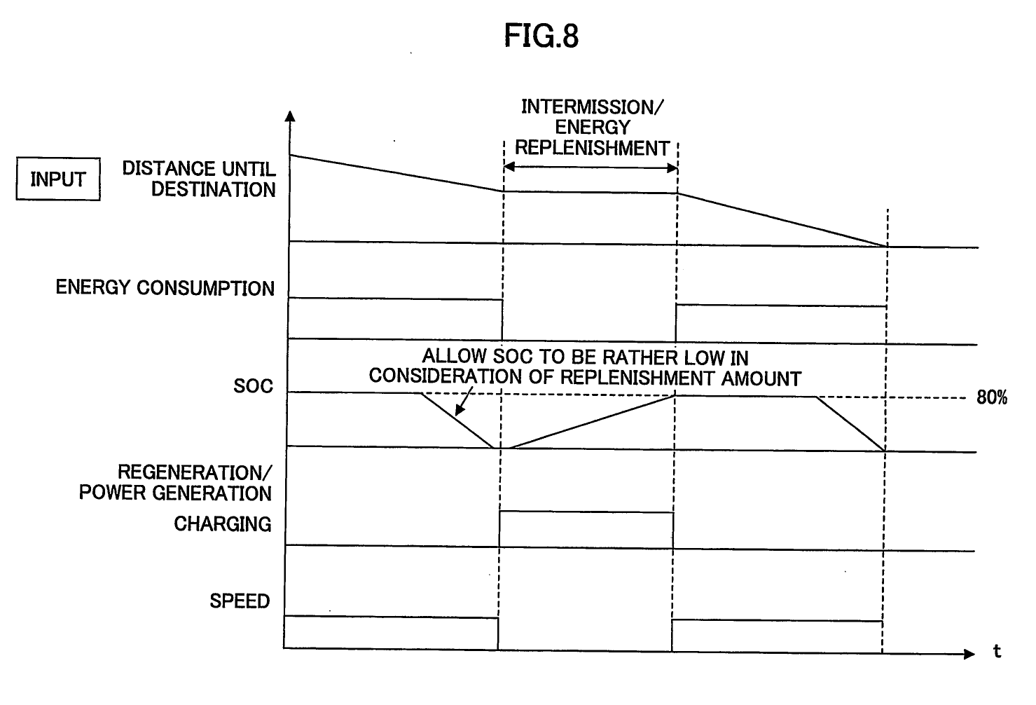

Further, in S21, a value that the state of charge SOC of the battery 12 of the vehicle should take at the time of arrival of a replenishment point as a result of running of the vehicle in the determined driving mode along the determined travel route is determined as a target SOC. Specifically, as shown in FIG. 8, the target SOC in a term preceding intermission/energy replenishment at the replenishment point is determined such that the state of charge SOC is allowed to be the minimum value (for example, 0) before arriving at the replenishment point.

Then, in S22 of FIG. 5, the actuator 44 is controlled such that the determined target SOC is achieved.

Subsequently, in S23, based on the difference between the cabin temperature and the outside air temperature, the air conditioning system 46 is controlled such that the target temperature is achieved. On this occasion, an air ventilation function (air ventilation by using the difference between the cabin temperature and the outside air temperature), a heat exchange function (cabin temperature adjustment by using the difference between the cabin temperature and the outside air temperature), and a water cooling function (a function of cooling the body and the battery 12 of the vehicle with water) are also achieved, which also reduces energy consumption.

Then, in S24, the lighting system 48 is controlled in the night. The lighting system 48 is controlled such that the target brightness is achieved. In S24, the lighting system 48 is efficiently controlled in accordance with the brightness in the vicinity of the vehicle, which also reduces energy consumption.

Execution of the driving support program ends with the above control.

As is clear from the above description, a part of the computer 70, which part carries out SI of FIG. 5, forms the target setting means 100 (FIG. 4) in association with the input apparatus 24 (FIG. 1). A part of the computer 70, which part carries out S2 through S6, S13, S14, S16 and S17 of FIG. 5, forms the environmental information obtaining means 102 (FIG. 4) in collaboration with the communication apparatus 32 and the navigation system 34 (FIG. 1).

Additionally, a portion of a part of the computer 70, which part carries out S7 through S9 of FIG. 5, forms the travel route determination means 120 (FIG. 4). Another portion of the part of the computer 70, which part carries out S7 through S9 of FIG. 5, forms the driving mode determination means 122 (FIG. 4).

Further, a portion of a part of the computer 70, which part carries out S9 through S10 of FIG. 5, forms the energy replenishment mode determination means 124 (FIG. 4). A part of the computer 70, which part carries out S21 of FIG. 5, forms the target SOC determination means 126 (FIG. 4). A part of the computer 70, which part carries out S11, S20, and S22 through S24 of FIG. 5, forms the driving execution means 128 (FIG. 4).

As is clear from the above description, in the present embodiment, the environmental information obtaining means 102 forms an example of the “obtaining part” of the above-mentioned item (1), and the target setting means 100, the travel route determination means 120, the driving mode determination means 122, the energy replenishment mode determination means 124, the target SOC determination means 126 and the driving execution means 128 form an example of the “control part” in the item (1) in collaboration with each other.

Additionally, in the present embodiment, each of the battery 12, the power system 14 and the motor 20 (only at the time of energy regeneration) forms an example of the “supply part” in the item (1), and each of the motor 20 (only at the time of driving the vehicle), the actuator 44, the air conditioning system 46, and the lighting system 48 forms an example of the “consumption part” in the item (1).

Further, in the present embodiment, the motor 20 forms an example of the “first part” in the item (1), and each of the actuator 44, the air conditioning system 46, and the lighting system 48 forms an example of the “second part” in the item (2).

In addition, in the present embodiment, each of the control system 104, the other vehicle, the mobile telephone used by the pedestrian, the signal system 110, the replenishment system 112 and the destination system 114 forms an example of the “information transmission apparatus” in the item (2).

Furthermore, in the present embodiment, the target setting means 100 forms an example of the “target setting part” in the above-mentioned item (4). The travel route determination means 120 and the driving mode determination means 122 form in collaboration an example of the “travel route/driving mode determination part” in the item (4). The target SOC determination means 126 forms an example of the “target remaining energy determination part” in the item (4). A part of the driving execution means 128 forms an example of the “actuation mode determination part” in the item (4), and another part of the driving execution means 128 forms an example of the “realization part” in the item (4).

Additionally, in the present embodiment, the replenishment system 112 forms an example of the “external energy related apparatus” in any of the above-mentioned items (5) through (7).

Additionally, in the present embodiment, the energy replenishment mode determination means 124 forms an example of the “replenishment location/replenishment mode determination part” in the above-mentioned item (8).

Additionally, in the present embodiment, S2 through S6, S13, S14, S16 and S17 form an example of the “obtaining step” in the above-mentioned item (9) in collaboration with each other. S1, S7 through S12, S15, and S18 through S24 form an example of the “control step” in the item (9) in collaboration with each other.

The present invention is not limited to the specifically disclosed embodiments, and variations and modifications may be made without departing from the scope of the present invention.

The present application is based on Japanese priority application No. 2003-198684 filed on Jul. 17, 2003, the entire contents of which are hereby incorporated by reference.

1. A moving body energy management apparatus installed in a moving body having a supply part that supplies energy and a consumption part that consumes the energy supplied from the supply part, the consumption part having a first part that consumes the energy for moving the moving body, which is a first function, and a second part that consumes the energy for performing a function other than moving of the moving body, which is a second function relating to the moving body,
said moving body energy management apparatus comprising:
an obtaining part obtaining environmental information relating to an environment in which the moving body is placed; and
a control part controlling at least one of the consumption part and the supply part based on the environmental information obtained by the obtaining part such that the first function and the second function are both performed.

2. The moving body energy management apparatus as claimed in claim 1,
wherein the moving body comprises:
a sensor detecting at least one of a running state quantity of the moving body and the environment in which the moving body is placed;
a navigation system for detecting a current position of the moving body; and
a communication apparatus for communicating with an information transmission apparatus that is located outside the moving body and transmits information, and
wherein the obtaining part comprises an information obtaining part that obtains the environmental information by using one of the sensor, the navigation system, and the communication apparatus.

3. The moving body energy management apparatus as claimed in claim 2, wherein the control part comprises an estimation-type control part that estimates a state of the moving body, which state includes a future position of the moving body, based on the environmental information obtained by the obtaining part, and controls the at least one of the consumption part and the supply part based on the estimated state of the moving body.

4. The moving body energy management apparatus as claimed in claim 3, wherein the control part comprises a supply part control part that estimates the state of the moving body, which state includes the future position of the moving body, based on the environmental information obtained by the obtaining part, and controls the supply part with respect to energy supply between the supply part and an external energy related apparatus located outside the moving body.

5. The moving body energy management apparatus as claimed in claim 2, wherein the control part comprises a supply part control part that estimates a state of the moving body, which state includes the future position of the moving body, based on the environmental information obtained by the obtaining part, and controls the supply part with respect to energy supply between the supply part and an external energy related apparatus located outside the moving body based on the estimated state of the moving body.

6. The moving body energy management apparatus as claimed in claim 1, wherein the control part comprises an estimation-type control part that estimates a state of the moving body, which state includes a future position of the moving body, based on the environmental information obtained by the obtaining part, and controls the at least one of the consumption part and the supply part based on the estimated state of the moving body.

7. The moving body energy management apparatus as claimed in claim 6, wherein the control part comprises a supply part control part that estimates the state of the moving body, which state includes the future position of the moving body, based on the environmental information obtained by the obtaining part, and controls the supply part with respect to energy supply between the supply part and an external energy related apparatus located outside the moving body based on the estimated state of the moving body.

8. The moving body energy management apparatus as claimed in claim 1, wherein the control part comprises a supply part control part that estimates the state of the moving body, which state includes the future position of the moving body, based on the environmental information obtained by the obtaining part, and controls the supply part with respect to energy supply between the supply part and an external energy related apparatus located outside the moving body based on the estimated state of the moving body.

9. A moving body energy management method applied to a moving body having a supply part that supplies energy and a consumption part that consumes the energy supplied from the supply part, the consumption part having a first part that consumes the energy for moving the moving body, which is a first function, and a second part that consumes the energy for performing a function other than moving of the moving body, which is a second function relating to the moving body,
said method comprising the steps of:
obtaining environmental information relating to an environment in which the moving body is placed; and
controlling at least one of the consumption part and the supply part based on the environmental information obtained in the step of obtaining environmental information such that the first function and the second function are both performed.
